(19) United States
(12) Patent Application Publication
(10) Pub. No.: US 2026/0049689 A1
(43) Pub. Date: Feb. 19, 2026

(54) AVIATION HEADSET MOUNT ASSEMBLY

(71) Applicant: Greyman Mounts LLC, Sharpsburg, GA (US)

(72) Inventor: James Martenes Rega, Sharpsburg, GA (US)

(21) Appl. No.: 19/303,286

(22) Filed: Aug. 18, 2025

Related U.S. Application Data
(60) Provisional application No. 63/683,927, filed on Aug. 16, 2024.

(51) Int. Cl. F16M 13/02

(52) U.S. Cl. CPC F16M 13/022

(57) ABSTRACT

An aviation headset mount assembly that includes a unitary body with an upper end, a lower end opposing the upper end of the unitary body, a body length separating the upper and lower ends, rear surface configured to directly couple with an internal structure of an aircraft, a rear wall, and two cantilevered sidewalls each extending from the rear wall, terminating at an end sidewall surface displaced at least 1 in. from the rear wall to define a retention channel spanning from the upper end and toward the lower end, and having an arcuate shaped hook member extending outwardly from respective the end sidewall surface and defining an opening between the arcuate-shaped hook member and the respective end sidewall surface, thereby configured to retain both an electronic control module an headband of the aviation headset.

### FIELD OF THE INVENTION

The present invention relates generally to aircraft accessories, and more particularly, to an aviation headset mount assembly.

### BACKGROUND OF THE INVENTION

Aircraft pilots routinely employ expensive equipment when operating an aircraft including, without limitation, specially designed aviation headsets. The instrument panel and/or cockpit of jets, planes, and other aircraft typically feature a clip for hanging headsets thereon, but their shape, form, and design is inconvenient and causes the wires of the headset to stress and eventually tear, chip, or break. Existing prior art, therefore, significantly compromises the longevity of aviation headsets and contributes to their damage and breakage, resulting in increased costs for pilots.

Therefore, a need exists to overcome the problems with the prior art as discussed above.

### SUMMARY OF THE INVENTION

The invention provides an aviation headset mount assembly that overcomes the hereinafore-mentioned disadvantages of the heretofore-known devices and methods of this general type and that enables users to effectively, efficiently, and safely retain their headset to various types of aircrafts and other transportation vehicles.

With the foregoing and other objects in view, there is provided, in accordance with the invention, an aviation headset mount that includes a unitary body with an upper end, a lower end opposing the upper end of the unitary body, a body length separating the upper and lower ends, rear surface configured to directly couple with an internal structure of an aircraft, a rear wall, and two cantilevered sidewalls each extending from the rear wall, terminating at an end sidewall surface displaced at least 1 in. from the rear wall to define a retention channel spanning from the upper end and toward the lower end, and having an arcuate shaped hook member extending outwardly from respective the end sidewall surface and defining an opening between the arcuate-shaped hook member and the respective end sidewall surface.

In accordance with another feature, an embodiment of the present invention includes the unitary body having a clip member of an arcuate-shape, spanning from the upper end, and extending downwardly toward the lower end.

In accordance with a further feature of the present invention, the two cantilevered sidewalls are disposed in a parallel orientation with respect to one another and are coupled to the rear wall in a substantially perpendicular orientation relative to the rear wall.

In accordance with an exemplary feature of the present invention, the at least one of the two cantilevered sidewalls define an aperture interposed thereon.

In accordance with a further feature of the present invention, the two cantilevered sidewalls each include a retaining flange member disposed in the retention channel.

In accordance with an additional feature of the present invention, the retaining flange members are disposed proximal to the respective end sidewall surface of the two cantilevered sidewalls. Also in one embodiment, the retention channel tapers along the body length.

In accordance with yet another feature, an embodiment of the present invention includes the unitary body having a lower wall extending from the rear wall and disposed in the retention channel.

In accordance with an exemplary feature of the present invention, the retention channel spans the body length.

In accordance with a further feature, an embodiment of the present invention also includes the arcuate-shaped hook member having a first upper surface disposed adjacent to the end sidewall surface and oriented upward toward the upper end and a second upper surface disposed adjacent to the first upper surface and oriented toward both the end sidewall surface and rear wall, wherein the first upper surface and the second upper surface defining the opening.

In accordance with an additional feature of the present invention, the unitary body further defines an enclosed coupling channel spanning along the body length and opening from at least one of the upper and lower ends.

In accordance with the present invention, an aviation headset mount assembly is disclosed that includes a unitary body with an upper end, a lower end opposing the upper end of the unitary body, and a body length separating the upper and lower ends, a rear wall having a rear surface and a front surface opposing the rear surface, and two cantilevered sidewalls each extending from the rear wall, terminating at an end sidewall surface displaced from the rear wall to define a retention channel spanning the body length, and having an arcuate shaped hook member extending outwardly from respective the end sidewall surface, with a first upper surface disposed adjacent to the end sidewall surface and oriented upward toward the upper end and a second upper surface disposed adjacent to the first upper surface and oriented toward both the end sidewall surface and rear wall, wherein the first upper surface, the second upper surface, and the respective end sidewall surface define an opening for receiving a headband of a headset.

In accordance with an additional feature of the present invention, the two cantilevered sidewalls each include a retaining flange member disposed in the retention channel. Further, the retaining flange members are disposed proximal to the respective end sidewall surface of the two cantilevered sidewalls.

Although the invention is illustrated and described herein as embodied in an aviation headset mount assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one, wherein the utilization of “a” or “an” does not mean multiple structures with various functions may be utilized to equate to single claimed structure with claimed functionality. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the mount assembly or, where applicable, a direction where a length of an object is greater than the diameter or width of that same object.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIGS. 1-2 depict perspective views of an aviation headset mount assembly in accordance with one embodiment of the present invention;

FIG. 3 depicts an elevational rear view of the aviation headset mount assembly in FIG. 1;

FIG. 4 depicts an elevational front view of the aviation headset mount assembly in FIG. 1;

FIG. 5 depicts an elevational side view, that is the same as the opposing side, of the aviation headset mount assembly in FIG. 1;

FIGS. 6-7 depict bottom and top plan views of the aviation headset mount assembly in FIG. 1;

FIGS. 8-13 depict an elevational rear, perspective, elevational front, elevational side, bottom plan, and top plan views of an aviation headset mount assembly in accordance with another embodiment of the present invention, wherein the opposing elevational side view is the same with the aperture filled in;

FIGS. 14-19 depict an elevational rear, perspective, elevational front, elevational side, bottom plan, and top plan views of an aviation headset mount assembly in accordance with another embodiment of the present invention, wherein the opposing elevational side view is the same with the aperture filled in;

FIGS. 20-25 depict an elevational rear, perspective, elevational front, elevational side, bottom plan, and top plan views of an aviation headset mount assembly in accordance with another embodiment of the present invention, wherein the opposing elevational side view is the same with the aperture filled in;

FIGS. 26-31 depict an elevational rear, perspective, elevational front, elevational side, bottom plan, and top plan views of an aviation headset mount assembly in accordance with another embodiment of the present invention, wherein the opposing elevational side view is the same with the aperture filled in;

FIGS. 32-37 depict an elevational rear, perspective, elevational front, elevational side, bottom plan, and top plan views of an aviation headset mount assembly in accordance with another embodiment of the present invention, wherein the opposing elevational side view is the same; and

FIGS. 38-43 depict two perspective, elevational front, elevational side, bottom plan, and top plan views of an aviation headset mount assembly in accordance with another embodiment of the present invention.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

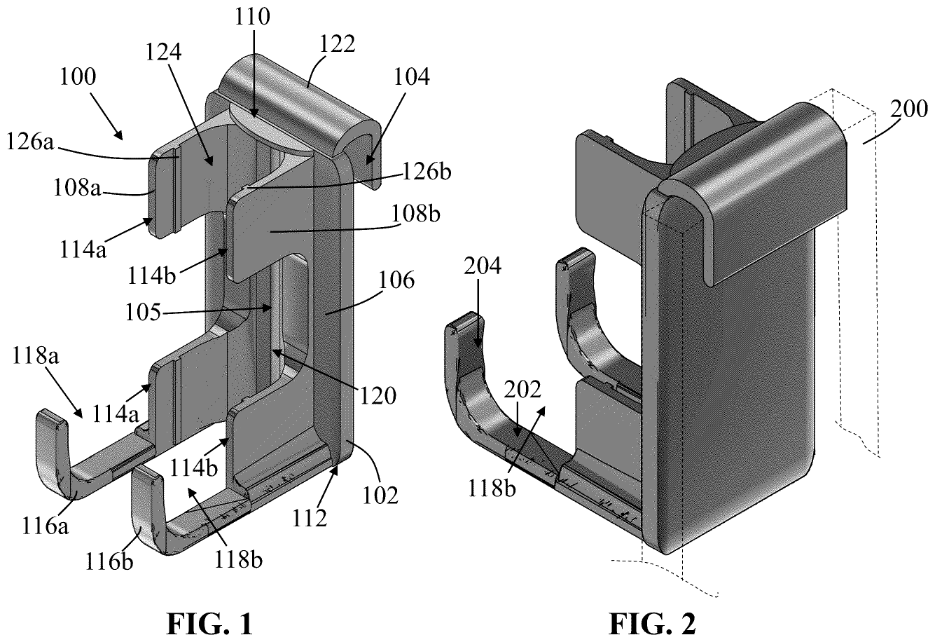

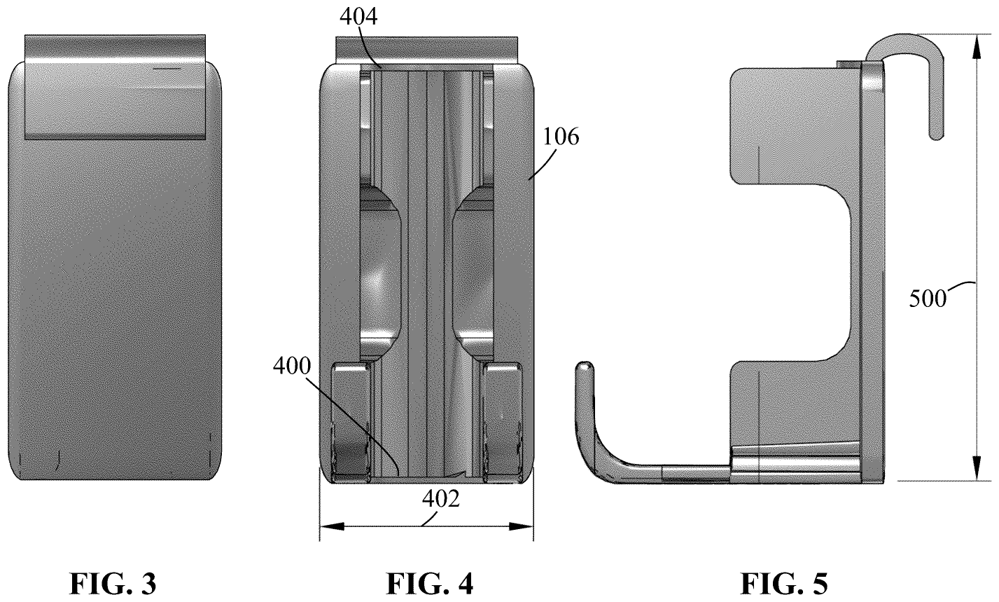

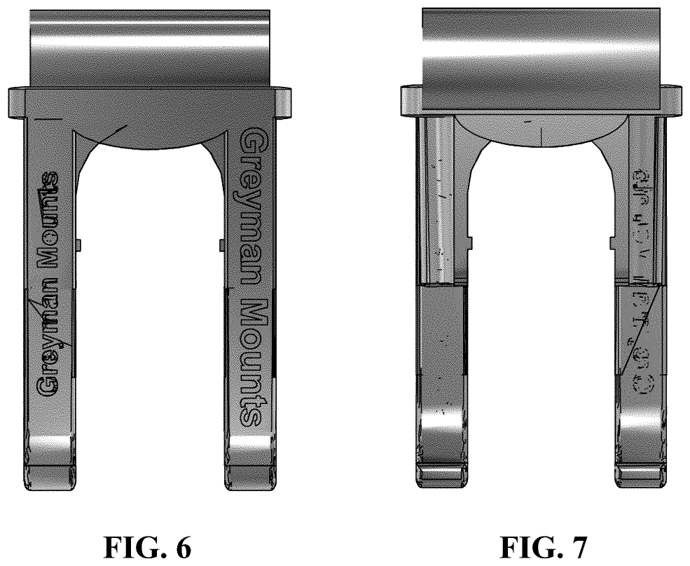

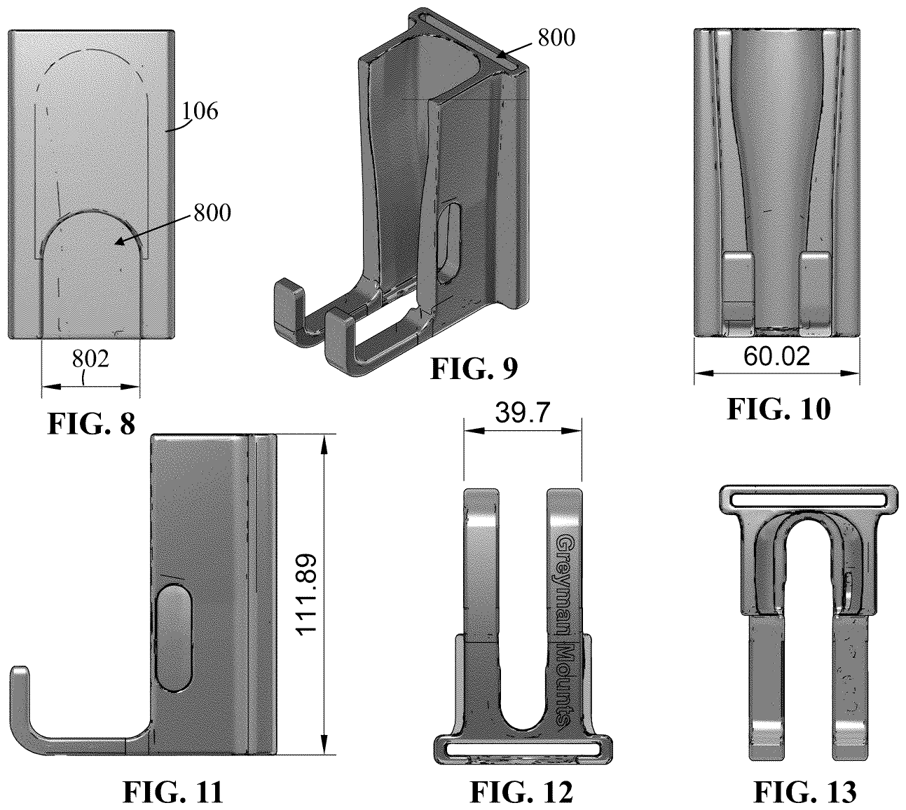

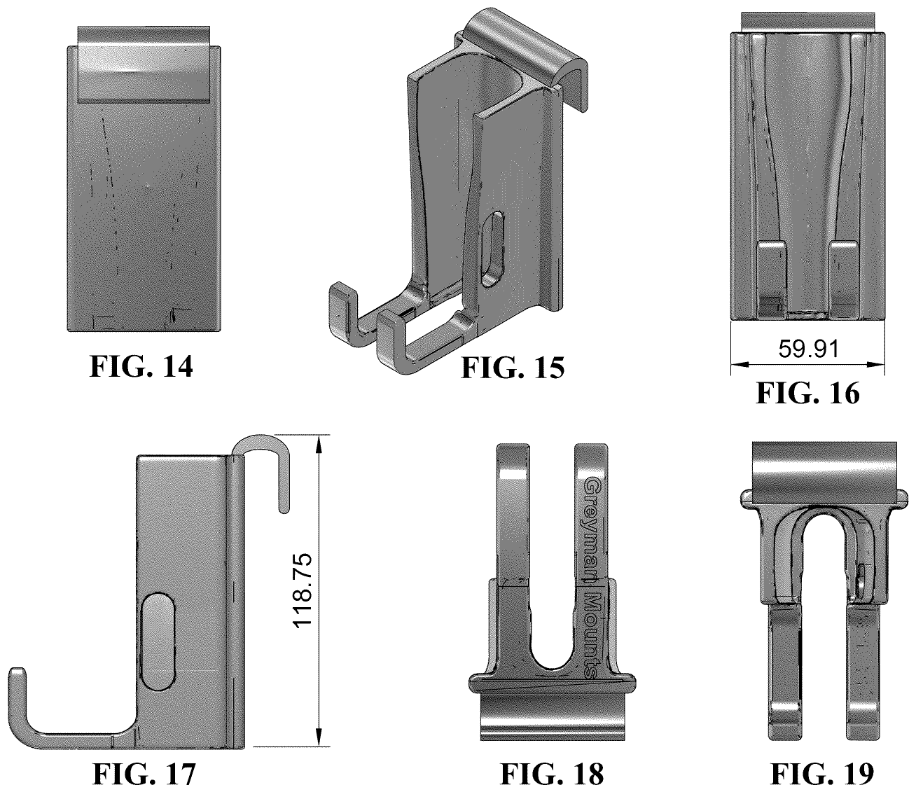

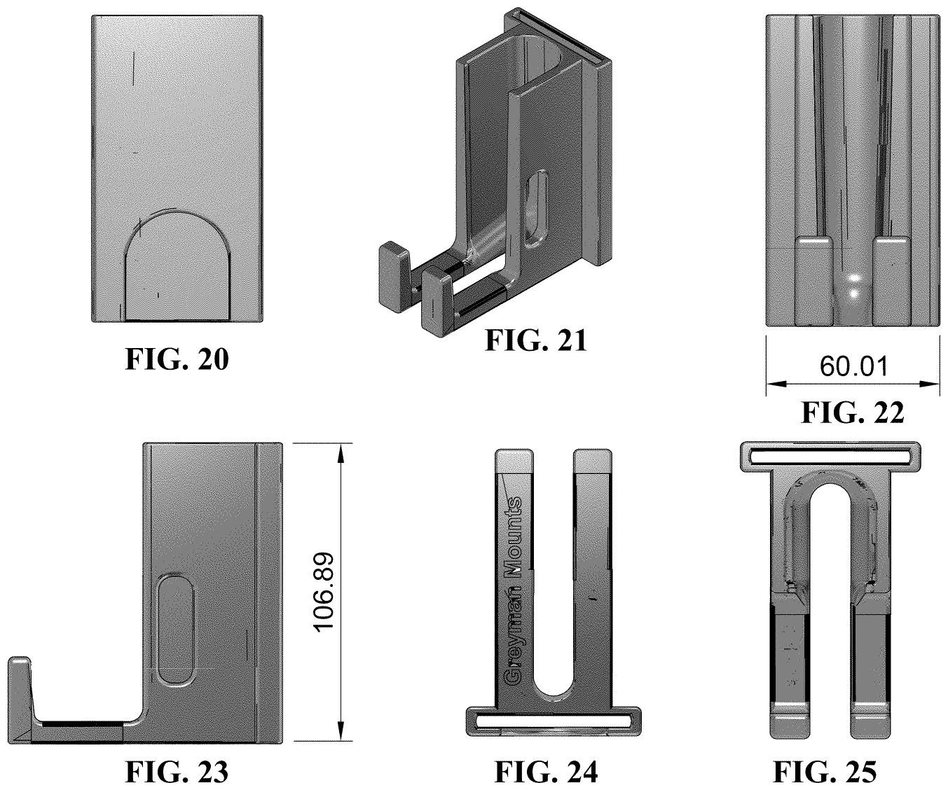

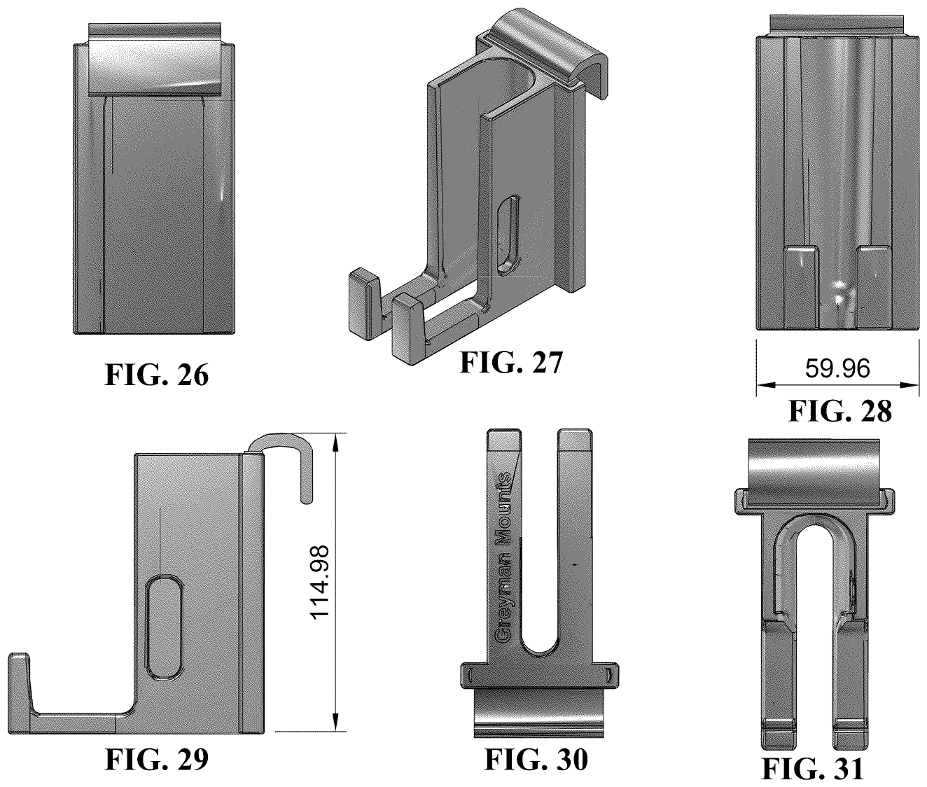

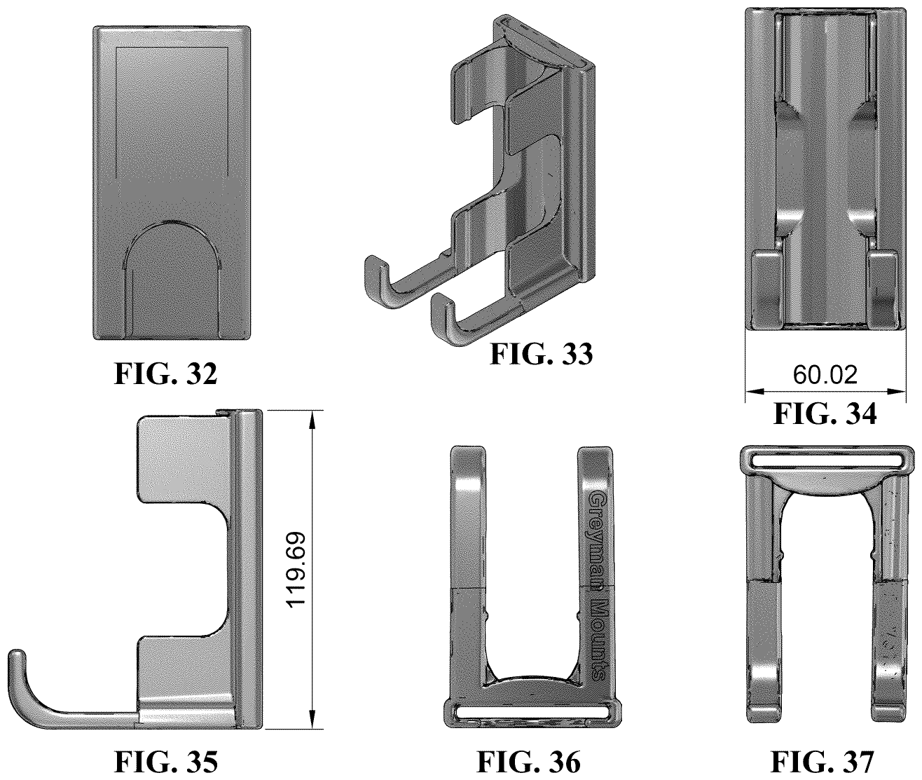

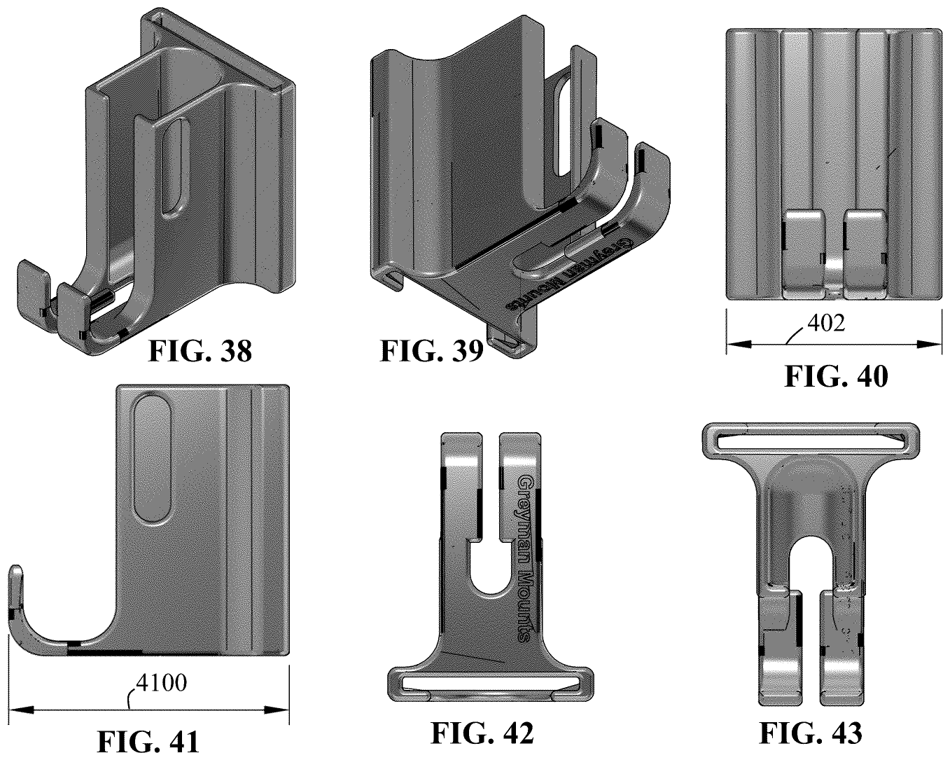

The present invention provides a novel and efficient aviation headset mount assembly. Specifically, referring to FIGS. 1-7, one embodiment of an aviation headset mount assembly 100 is shown. FIGS. 1-7 show several advantageous features of the present invention, but, as will be described below, the invention can be provided in several shapes, sizes, combinations of features and components, and varying numbers and functions of the components, as exemplified in FIGS. 8-43.

Referring now to FIG. 1, the aviation headset mount assembly 100 (also referred to herein as “assembly 100” for brevity) that includes a housing or body 102 operably configured to selectively mount to an existing aircraft headset clip or other similar structure. The assembly 100 selectively is configured to attach to an aircraft's already installed headset clip, which clips to the current headset clip and also provides a structure for receiving and retaining a control module box or other similar structure conventionally utilized with aviation headsets. The assembly 100 includes a headset clip to conveniently and safely hang one's aviation headset without compromising the longevity of the headset or otherwise contributing to the breakage of the headset. In exemplary embodiments of the present invention, the assembly 100 is of a substantially rigid, unitary, and durable material composition that can sustain the weight of an aviation headset and moves as a singular unit.

The body 102 of the assembly 100 also allows a user to slide the module box into it which the mount itself slides onto the Airbus installed headset oval clip. When installed, the assembly 100 is snug enough to not slide out when it is time to put it in the headset case but when it comes time to change the batteries, simply slide the module box out of the mount and change the batteries. Beneficially, the assembly 100 does not interfere with any of the buttons on the instrument panel. The body 100 also includes a split type design to allow for the cord passage through the mount to make the module box easy to slide in and out when needed. Moreover, the assembly 100 is operably configured to slide onto an aircraft's installed headset clip including, without limitation, on Airbus A319, A320, and A321 series aircraft.

More specifically, using FIGS. 1-7 as an example, the body 102 is unitary and has an upper end 110, a lower end 112 opposing the upper end 110 of the unitary body 102, and a body length 500 separating the upper and lower ends 110, 112. The upper and lower ends 110, 112 may be the terminal longitudinal ends of the body 102 and may include the clip member 122 or other attachment members of the body 102. The body length 500 is preferably 4-5 in (or 126 mm), but may be approximately larger or smaller to effectuate the intent of the present invention.

The body 102 may also include a rear surface 104 configured to directly couple with an internal structure (schematically represented in FIG. 2 as numeral 200) of an aircraft (which may include an equivalent vehicle other than an aircraft). The rear surface 104 is preferably part of a rear wall 106 that may abut against a fastening structure of the aircraft. As used herein, the term “wall” is intended broadly to encompass continuous structures, as well as separate structures that are coupled together so as to form a substantially continuous external surface. The body 102, namely the rear wall 106, may also include a front surface 105 that may define a retention channel 124 for beneficially receiving a control module or other longitudinal and/or elongate structure utilized with the headset as not accomplished with known headset mounts.

In one embodiment, the body 102, namely the rear wall 106, may have a clip member 122 that is formed in an arcuate-shape, spanning from the upper end 110, and extending downwardly toward the lower end 112. The clip member 122 may have a curved portion on it and may terminate into a linear-formed clip end surface less than 1 in. from the upper end 110. The internal structure 200 may be an elongated structure to which the clip member 122 or, as shown in FIGS. 8-9 by way of example, one or more portions of the rear wall 106. More specifically, the unitary body 102, including the rear surface 104, may define an enclosed coupling channel 800 spanning along the body length 500 and opening from at least one of the upper and lower ends 110, 112. FIGS. 8-9 depict the coupling channel 800 opening from both sides, wherein the user may slide the rear wall 106 over the internal structure 200 such that the internal structure 200 is inserted in the coupling channel 800 and frictionally and/or compressively coupling to the unitary body 102 in the coupling channel 800. In one embodiment, the opening is recessed and shaped to accommodate a portion of the internal structure 200 and may be a width 802 of 1-2 in. (or 35 mm). The coupling channel 800 may also taper in width at it spans the body length 500. The overall width 402 of the rear wall 106

The unitary body 102 also includes two cantilevered sidewalls 108a-b that oppose or face one another and extending from the rear wall 106. Said another way, each of the two cantilevered sidewalls 108a-b may include an end directly coupled to the rear wall 106 and have an opposing end permanently unconnected to any structure. Each of the two cantilevered sidewalls 108a-b terminate at an end sidewall surface 114a-b that may be displaced at least 1 in. from the rear wall 106 to define a retention channel 124 spanning from the upper end 110 and toward the lower end 112. The end sidewall surface 114a-b may continually span linearly along the body length 500 and may include a recessed opening 120 as exemplified in FIG. 1 for exposing the buttons on the module retained by the body 102. In one embodiment, one or more of two cantilevered sidewalls 108a-b define an aperture 120 interposed thereon that is preferably enclosed, thereby providing more surface area for retaining the module in the retention channel 124.

In one embodiment, the cantilevered sidewalls 108a-b are disposed in a parallel orientation with respect to one another and are coupled to the rear wall 106 in a substantially perpendicular orientation relative to the rear wall 106 (as exemplified best in FIG. 1 and FIG. 4). The sidewalls 108a-b may be molded onto the rear wall 106 or coupled thereto using welding and/or one or more fasteners. Said differently, the unitary body 102 may define a centroid or center of mass that defines an axis by which the sidewalls 108a-b are symmetrically disposed, thereby ensuring equal weight distribution of the headset and module they are retaining.

The two cantilevered sidewalls 108a-b may also include a retaining flange member 126a-b disposed in the retention channel 124 and project from an inner surface of the respective sidewall 108a-b. The retaining flange members 126a-b may be of a uniform height (e.g., less than 0.2 in.) relative to the inner surface and disposed proximal (i.e., at or near, within 1 in.) to the respective end sidewall surface 114a-b of the two cantilevered sidewalls 108a-b. The retaining flange members 126a-b serve as an outer stop for transversely retaining the module retained within the retention channel 124. Each of the retaining flange members 126a-b may be coated or lined with an elastomeric material for compressing the module within the body 102. The rear wall 106 and/or an upper and lower wall may also serve to retain the module in the body 102.

In one embodiment, the retention channel 124 tapers in width along the body length 500, whereby the module inserted therein is configured to seat inside of the body 102 with the buttons exposed in the openings 120 or selective, quick, and efficient access by the user. The unitary body 102 may also include a lower wall 400 and an upper wall 404 extending from the rear wall 106 and disposed in the retention channel 124 to restrict movement of the control module. The lower and upper walls 400, 404 preferably only partially extend in the retention channel 124 less than approximately 0.2 in so the user can maneuver the module inside the retention channel 124 and snap into place using the flanges 126a-b. Beneficially, the retention channel 124 is designed to span the body length 500, thereby providing a through hole for the wiring of the module that is connected to the headset.

Beneficially, the unitary body 102 also includes an arcuate shaped hook member 116a-b that may include a horizontal portion and a vertical portion. The arcuate shaped hook member 116a-b may include a circular surface and/or planar surfaces that form the arcuate shape. Each of the hook members 116a-b extend outwardly from respective the end sidewall surface 114a-b and define an opening 118a-b between the arcuate-shaped hook member 116a-b and the respective end sidewall surface 114a-b to retain the headband portion of an aviation headset. Said differently, the arcuate-shaped hook member 116a-b includes a first upper surface 202 disposed adjacent to the end sidewall surface 114a-b and oriented upward toward the upper end 110 and a second upper surface 204 disposed adjacent to the first upper surface 202 and oriented toward both the end sidewall surface 114a-b and rear wall 106. Both the first upper surface 202, the second upper surface 204, and the respective end sidewall surface 114a-b that may linearly extend upward from the second upper surface 204 define the opening 118. The opening 118 may be a length that is approximately half of or less than of the overall length 4100 (represented in FIG. 41 with numeral 4100) of the body 102.

In one embodiment, the hook members 116a-b may define a gap in between the hook members 116a-b that extend continuously from an outermost surface of the body 102 and into the retention channel 124. In one embodiment, as exemplified in FIG. 39, the retention channel 124 may define a large diameter for portions of the wire and enable effective and efficient placement and removal of the module onto the body 102.

Although a specific order of executing utilization steps has been disclosed and depicted in the drawings, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. An aviation headset mount assembly comprising:
a unitary body with an upper end, a lower end opposing the upper end of the unitary body, a body length separating the upper and lower ends, rear surface configured to directly couple with an internal structure of an aircraft, a rear wall, and two cantilevered sidewalls each extending from the rear wall, terminating at an end sidewall surface displaced at least 1 in. from the rear wall to define a retention channel spanning from the upper end and toward the lower end, and having an arcuate shaped hook member extending outwardly from respective the end sidewall surface and defining an opening between the arcuate-shaped hook member and the respective end sidewall surface.

2. The aviation headset mount assembly according to claim 1, wherein the unitary body further comprises:
a clip member of an arcuate-shape, spanning from the upper end, and extending downwardly toward the lower end.

3. The aviation headset mount assembly according to claim 1, wherein the two cantilevered sidewalls are disposed in a parallel orientation with respect to one another and are coupled to the rear wall in a substantially perpendicular orientation relative to the rear wall.

4. The aviation headset mount assembly according to claim 1, wherein at least one of the two cantilevered sidewalls define an aperture interposed thereon.

5. The aviation headset mount assembly according to claim 1, wherein the two cantilevered sidewalls each include a retaining flange member disposed in the retention channel.

6. The aviation headset mount assembly according to claim 5, wherein the retaining flange members are disposed proximal to the respective end sidewall surface of the two cantilevered sidewalls.

7. The aviation headset mount assembly according to claim 5, wherein the retention channel tapers along the body length.

8. The aviation headset mount assembly according to claim 5, wherein the unitary body further comprises:
a lower wall extending from the rear wall and disposed in the retention channel.

9. The aviation headset mount assembly according to claim 8, wherein the retention channel spans the body length.

10. The aviation headset mount assembly according to claim 1, wherein the arcuate-shaped hook member further comprises:
a first upper surface disposed adjacent to the end sidewall surface and oriented upward toward the upper end; and
a second upper surface disposed adjacent to the first upper surface and oriented toward both the end sidewall surface and rear wall, the first upper surface and the second upper surface defining the opening.

11. The aviation headset mount assembly according to claim 1, wherein the unitary body further defines an enclosed coupling channel spanning along the body length and opening from at least one of the upper and lower ends.

12. An aviation headset mount assembly comprising:
a unitary body with:
an upper end, a lower end opposing the upper end of the unitary body, and a body length separating the upper and lower ends;
a rear wall having a rear surface and a front surface opposing the rear surface; and
two cantilevered sidewalls each extending from the rear wall, terminating at an end sidewall surface displaced from the rear wall to define a retention channel spanning the body length, and having an arcuate shaped hook member extending outwardly from respective the end sidewall surface, with a first upper surface disposed adjacent to the end sidewall surface and oriented upward toward the upper end and a second upper surface disposed adjacent to the first upper surface and oriented toward both the end sidewall surface and rear wall, wherein the first upper surface, the second upper surface, and the respective end sidewall surface define an opening for receiving a headband of a headset.

13. The aviation headset mount assembly according to claim 12, wherein the two cantilevered sidewalls each include a retaining flange member disposed in the retention channel.

14. The aviation headset mount assembly according to claim 12, wherein the retaining flange members are disposed proximal to the respective end sidewall surface of the two cantilevered sidewalls.

15. The aviation headset mount assembly according to claim 12, wherein the retention channel tapers along the body length.

16. The aviation headset mount assembly according to claim 12, wherein the unitary body further comprises:
a lower wall extending from the rear wall and disposed in the retention channel.

17. The aviation headset mount assembly according to claim 12, wherein the unitary body further comprises:
a clip member of an arcuate-shape, spanning from the upper end, extending downwardly toward the lower end, and including the rear surface configured to directly couple with an internal structure of an aircraft.

18. The aviation headset mount assembly according to claim 12, wherein the end sidewall surface is displaced at least 1 in. from the rear wall to define the retention channel.
